(19) United States
(12) Patent Application Publication
(10) Pub. No.: US 2020/0338776 A1
(43) Pub. Date: Oct. 29, 2020

(54) Web and Rope Cutting Tool

(71) Applicant: Med-Eng, LLC, Jacksonville, FL (US)

(72) Inventors: Tony Williamson, Orleans (CA); Marc Evans, Navan (CA); Jeremi Deveau, Ottawa (CA)

(73) Assignee: Med-Eng, LLC, Jacksonville, FL (US)

(21) Appl. No.: 16/393,267

(22) Filed: Apr. 24, 2019

(51) Int. Cl. B26D 7/00; B26D 1/00; B26D 1/03

(52) U.S. Cl. CPC B26D 7/0006; B65B 69/0025; B26D 1/035; B26D 1/0006

(57) ABSTRACT

A cutting tool for cutting a workpiece such as a rope or a web includes a body defining first and second channels closed by respective first and second movable gates. A first cutting member is at a narrow end of the first channel, and a second cutting member is at a narrow end of the second channel. The body has surface portions adjacent to the second cutting member that are adapted to deform a flat workpiece engaging the second cutting member into a non-flat shape to increase the stiffness of the workpiece as it engages the second cutting member.

### BACKGROUND OF THE INVENTION

This invention relates to the art of explosive ordnance disposal. In particular, this invention relates to a tool for cutting a web or rope that is attaching an explosive device to a structure.

Explosive devices are, at times, attached to a structure or other device with a rope or web, a web being something having a flat configuration like a strap or belt, for example. It is desirable to remove the explosive device from the structure or other device and transport it to another location for disarming and/or disposal. To accomplish this, it is necessary to cut any attachment member. This process entails going up to the explosive device, attaching a cutting tool to the attachment member, withdrawing from the scene, and then remotely actuating the cutting tool. Once the rope or web is cut, the device can be removed from the scene. This process can be especially difficult if the explosive device is underwater and the actions must be undertaken by a diver.

Known tools that are used for this purpose are typically simple hooks with a cutting blade attached. The hook is pulled or pushed via a rope from a remote location to cut the attachment cable. Such tools can be difficult to secure to the attachment member so that they will stay in place to allow for remote pulling.

In addition, known tools can have difficulty cutting a web or strap, which may tend to bunch up in the tool and make cutting difficult or impossible. This is because the web being cut has a longitudinal extent (in the direction of relative movement of the blade and web) that is substantially greater than the material thickness. When the blade first engages the edge of the web, a force is exerted on the web in the longitudinal direction. Even if the web is taut laterally across the blade, this longitudinally directed force can cause the web to bunch up and/or buckle in the longitudinal direction. (As an illustrative example, a piece of paper that is stood up vertically on top of a desk or table, with its lower edge resting on the table, and that is subjected to a downward force on its top edge, will buckle or collapse because it has little strength in that vertical direction.) If a cutting tool engages a web but does not cut it, the worker needs to go back to the site of the explosive device and start the process over again, which increases the danger to the worker.

### SUMMARY OF THE INVENTION

The present invention is, in one embodiment, a cutting tool for cutting a workpiece such as a rope or a web, comprising a body defining first and second channels closed by respective first and second movable gates. A first cutting member is at a narrow end of the first channel, and a second cutting member is at a narrow end of the second channel. The body has surface portions adjacent to the second cutting member that are adapted to deform a flat workpiece engaging the second cutting member into a non-flat shape to increase the stiffness of the workpiece as it engages the second cutting member.

### BRIEF DESCRIPTION OF THE DRAWINGS

Further features of the invention will become apparent from a reading of the following description together with the accompanying drawings, in which:

FIG. 1 is a schematic illustration showing an explosive device held to a piling of a pier with a round rope, and showing a cutting tool of the present invention attached to the rope prior to cutting of the rope with the tool;

FIG. 2 is a schematic illustration similar to FIG. 2 showing an explosive device attached to a piling of a pier with a flat web, and showing the cutting tool of FIG. 1 attached to the web prior to cutting of the web with the tool;

FIG. 3 is a front perspective view of the cutting tool;

FIG. 4 is a front elevational view of the cutting tool;

FIG. 5 is a rear elevational view of the cutting tool;

FIG. 6 is an exploded perspective view of the cutting tool;

FIG. 7 is a sectional view taken generally along line 7-7 of FIG. 4;

FIG. 8 is a sectional view taken generally along line 8-8 of FIG. 4;

FIG. 9 is a perspective view of a portion of the cutting tool of FIG. 1;

FIGS. 10A and 108 are perspective views illustrating the use of a pulling attachment and pushing attachment, respectively, with the cutting tool;

FIGS. 11 through 16 are a series of elevational views illustrating the use of the cutting tool to cut a round workpiece;

FIGS. 17 and 18 are views illustrating the user of the cutting tool to cut a command wire into three pieces; and

FIGS. 19 through 22 are a series of elevational views illustrating the use of the cutting tool to cut a workpiece that is a flat web.

### DETAILED DESCRIPTION OF AN EMBODIMENT OF THE INVENTION

The present invention relates to a tool for cutting a web or rope. The invention is applicable to tools of varying configurations and constructions. As representative of the invention, the drawings illustrate a tool 10 that is a first embodiment of the invention.

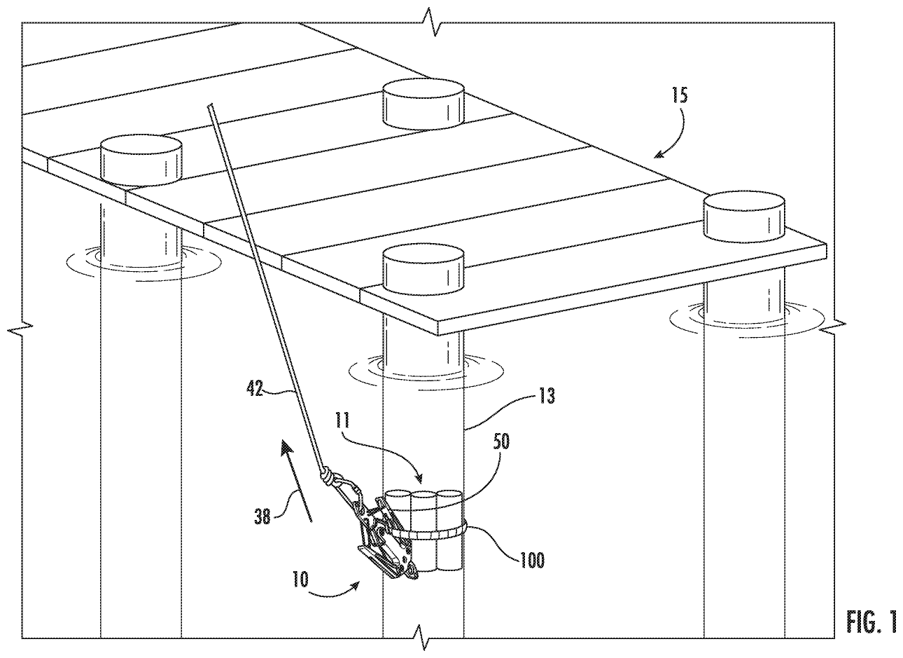

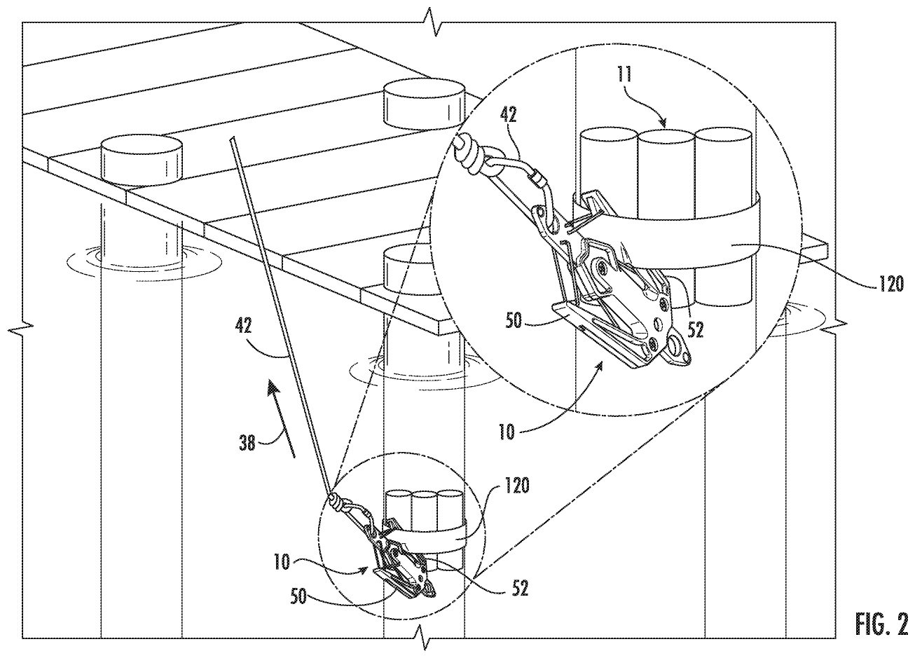

The tool 10 is especially useful for cutting a member that secures an explosive device or other device to an object such as a structure. Such a situation is illustrated schematically in FIG. 1 in which an explosive device 11 is shown secured, by a rope 100, to a piling 13 of a pier 15. The rope 100, as shown and described in detail below, has a round cross-sectional configuration. FIG. 2 illustrates a similar situation, in which the explosive device 11 is secured by web 120. The web 120, as shown and described in more detail below, has a flat, strap-like cross-sectional configuration. As described below, the tool 10 is specially configured to remotely cut either the rope 100 or the web 120.

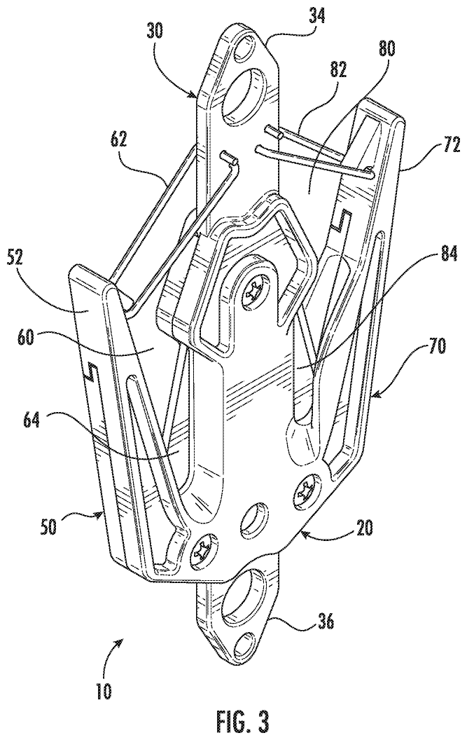

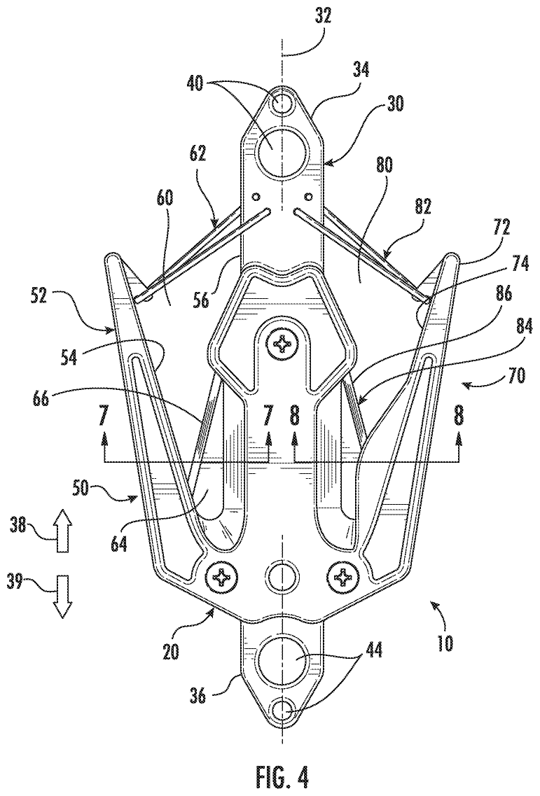

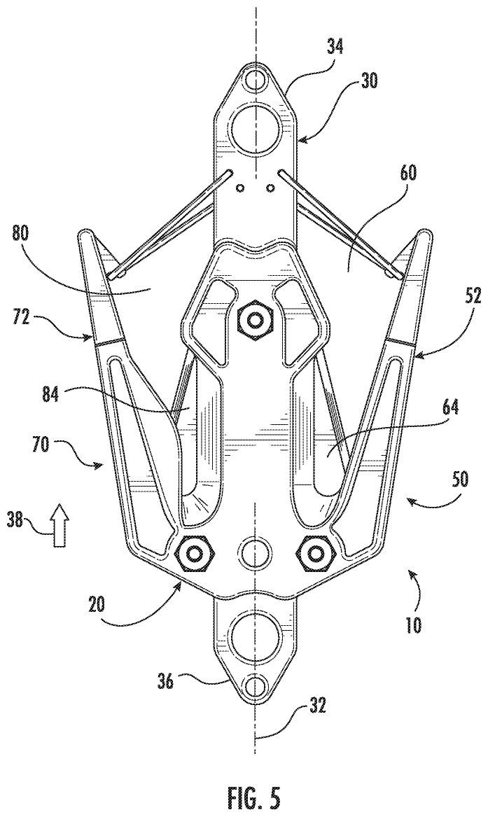

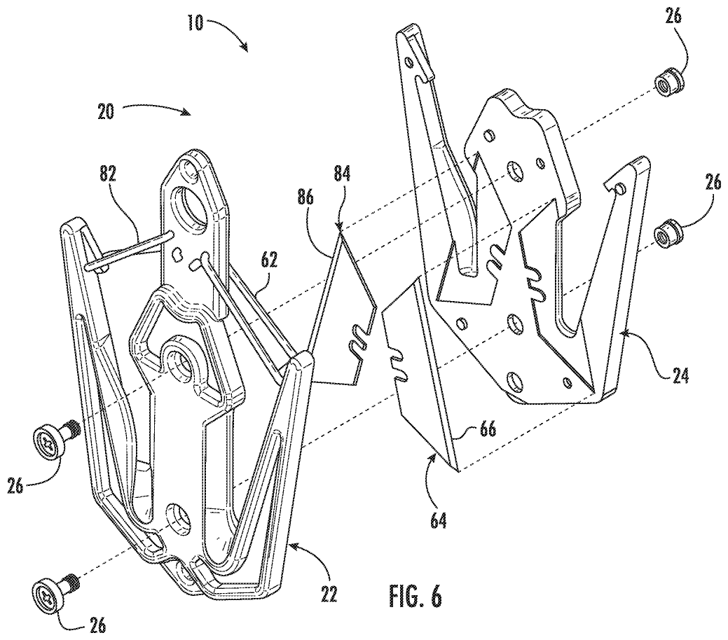

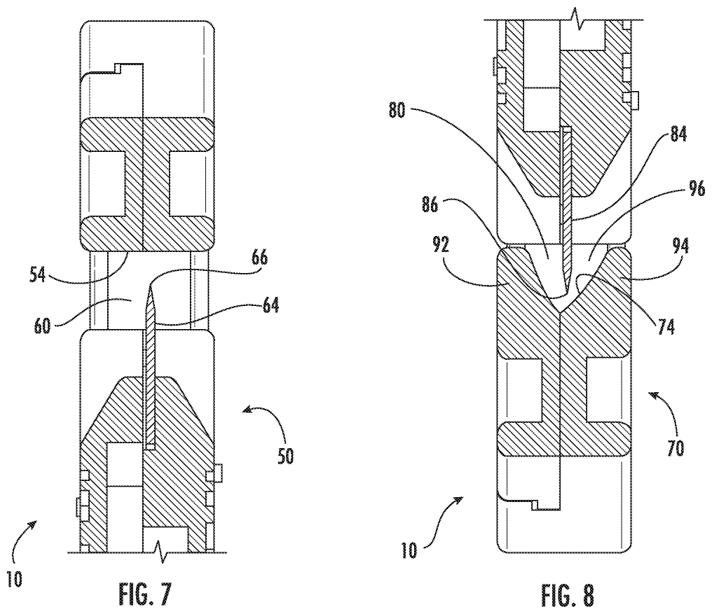

The tool 10 (FIGS. 3-9) includes as its main components a body 20, two cutting members 64 and 84, and two gates 62 and 82. The body 20 could be formed from plastic (preferred) or another material. The body 20 is preferably formed as two pieces 22 and 24 (FIG. 6) joined together by a number of fasteners 26, as shown in FIG. 6. In this case, the cutting members 64 and 84, which are captured between the two body pieces 22 and 24, are easily removable and replaceable as needed.

The body 20 has a center post 30 that extends along a longitudinal central axis 32 of the tool 10. The center post 30 has first and second end portions 34 and 36. For purposes of this description the axis 32 is said to define a cutting direction 38 that is toward the top of the page as viewed in FIG. 2, and an opposite removal direction 39.

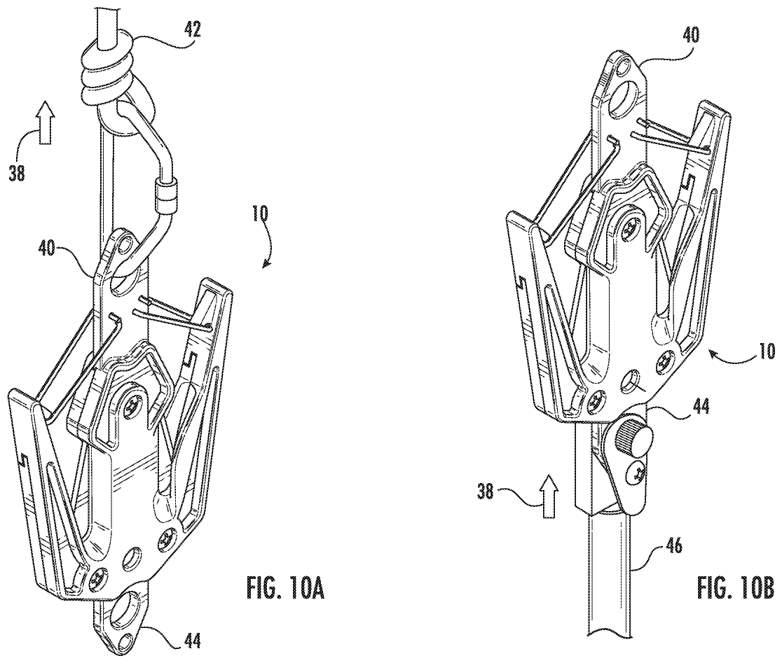

The body 20, and specifically the center post 30, has portions at its opposite ends that define connection areas for attachment of pushing and/or pulling devices. Such attachment is illustrated schematically in FIGS. 10A and 10B. Specifically, a pulling connection area 40 at the inner end portion 34 can be used to attach a rope, wire, cable, stick, or other pulling device 42. Pulling force on that device 42 causes the tool 10 to move in the cutting direction 38. A pushing connection area 44 at the opposite end of the tool 10 can be used to attach a stick or other pushing device 46; pushing force on that element 46 causes the tool 10 to move in the cutting direction 38.

The tool 10 has a “rope side” 50 on one side of the center post 30 and or axis 32 (to the left as viewed in FIGS. 3 and 4) and a “web side” 70 on the opposite side of the center post and axis (to the right as viewed in FIGS. 3 and 4.) The rope side 50 is especially configured to be used, in a manner as described below, for cutting a workpiece that is usually round, like a rope, cable, wire, etc. The web side 70 is especially configured to be used, in a manner described below, for cutting a workpiece that is flat, like a web or strap.

On the rope side 50 of the tool 10, the body 20 includes a first wing 52 that extends at an acute angle from the inner end portion 34 of the center post 30 and in a direction toward the outer end portion 36 of the center post 30. The first wing 52 has a first wing surface 54 that is presented toward an outward facing surface 56 of the center post 30. The first wing surface 54 is flat, not contoured.

The center post 30 and the first wing 52 define between them a V-shaped first channel 60. A first gate 62 is located at the outer end of the first channel 60. The first gate 62 in the illustrated embodiment is a wire gate, although in other embodiments of the invention the first gate could be formed differently. The first gate 62 is pivotally connected to the first wing 52, and is spring biased to a closed position as shown in FIGS. 3 and 4. When the first gate 62 is in the closed position, it closes the outer end of the first channel 60. The purpose of the first gate 62 is to admit a workpiece into the first channel 60, then retain the workpiece in the first channel, blocking it from movement out of the first channel in the removal direction 39.

The first channel 60, because it is V-shaped, tapers away from the first gate 62. The first channel 60 terminates, at its narrow end opposite the first gate 62, in a first cutting member 64, which may be a box cutter blade, for example. The first cutting member 64 has a first cutting edge 66 that extends at an oblique angle to the cutting direction 38, so that the first channel terminates in a tapering V-shape end adapted and configured to cut a workpiece moving down the first channel.

On the web side 70 of the tool 10, the body 20 includes a second wing 72 that extends at an acute angle from the inner end portion 34 of the center post 30 and in a direction toward the outer end portion 36 of the center post. The second wing 72 has a second wing surface 72, described below in detail, that is presented toward an outward facing surface of the center post 30.

The center post 30 and the second wing 72 define between them a V-shaped second channel 80. A second gate 82 is located at the outer end of the second channel 80. The second gate 82 in the illustrated embodiment is a wire gate, although in other embodiments of the invention the second gate 82 could be formed differently. The second gate 82 is pivotally connected to the second wing 72, and is spring biased to a closed position as shown in FIGS. 3 and 4. When the second gate 82 is in the closed position, it closes the outer end of the second channel 80. The purpose of the second gate 82 is to admit a workpiece into the second channel 80, then retain the workpiece in the second channel 80 against movement in the removal direction 39.

The second channel 80, because it is V-shaped, tapers away from the second gate 82. The second channel 80 terminates opposite the second gate 82 at its narrow end in a second cutting member 84, which may be a box cutter blade, for example. The second cutting member 84 has a second cutting edge 86 that extends at an oblique angle to the cutting direction 38, so that the second channel 80 terminates in a tapering V-shaped end to capture a workpiece that is drawn down along the second channel.

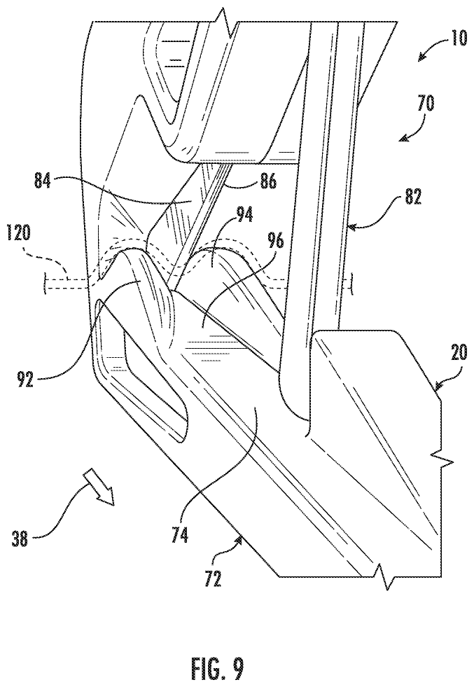

Unlike the first wing surface 52, the second wing surface 72 (FIG. 9) is not flat. Rather, the second wing surface 72 is contoured to better enable cutting of a web in the second channel 80 on the web side 70 of the tool 10. The second wing surface 72 includes a flat major side surface and two upstanding ribs 92, 94 that define between them a trough 96. The ribs 92, 94 and the trough 96 extend in a direction along the length of the second wing 72, on the portion of the second wing that is close to the second cutting edge 86. The upstanding ribs 96 have the appearance of human bicep muscles when viewed from the side as in FIG. 6.

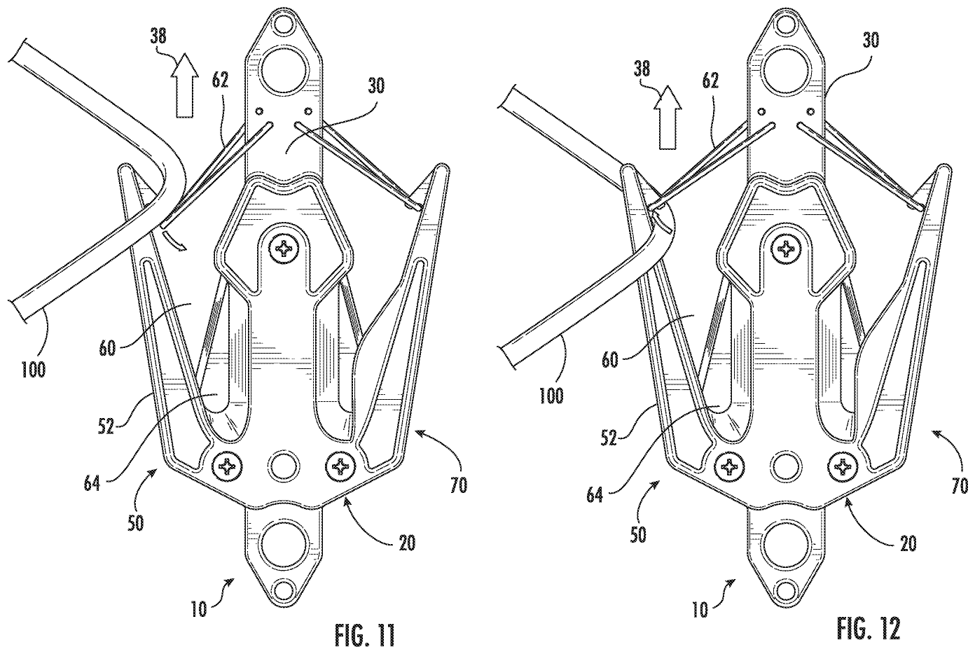

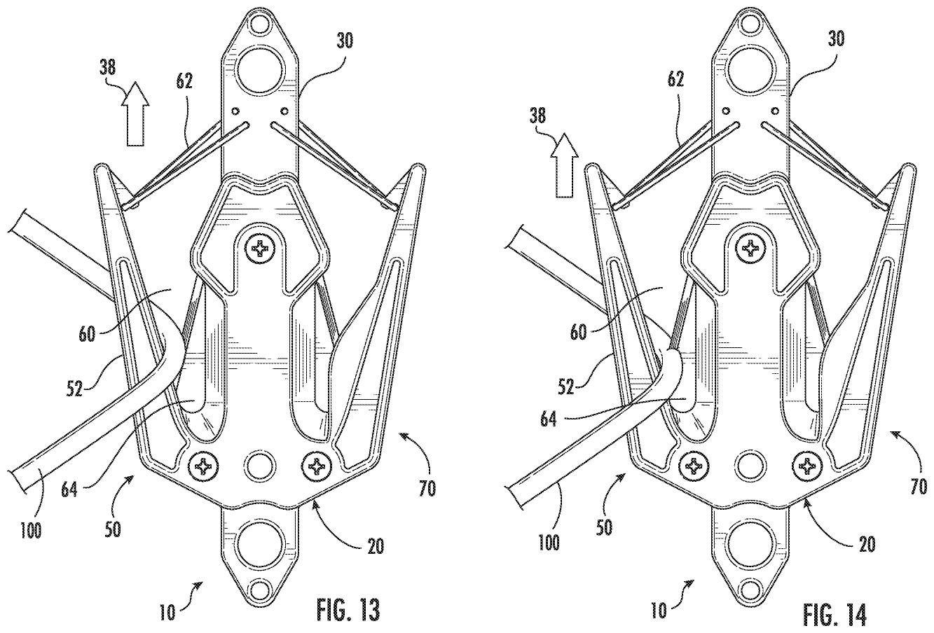

The rope side 50 of the tool 10 is adapted for cutting of a round workpiece such as a rope or cable. This process is illustrated in FIGS. 11-16. To start the process, the tool 10 is moved relative to the rope 100 so that the first gate 62 engages the rope. This movement occurs in the cutting direction 38 and may be accomplished by pushing or pulling. The engagement of the rope 100 with the first gate 62 causes the first gate to be swung open, allowing the rope to enter into the first channel 60. When the rope 100 moves far enough into the first channel 60, the first gate 62 closes behind the rope, blocking the rope from exiting the first channel.

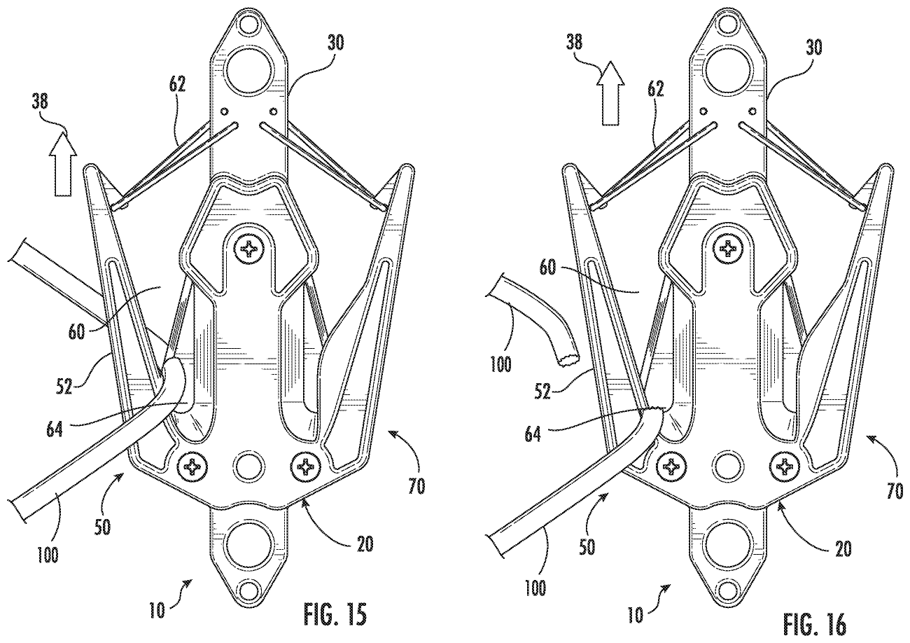

Sufficient further movement of the tool 10 in the cutting direction 38 causes the first cutting member 64 to engage the rope 100. The first cutting edge 66 cuts into and through the rope 100, severing it into two pieces as shown in FIG. 16. At this point, the rope 100 is released from the explosive device 11 and the explosive device can be moved.

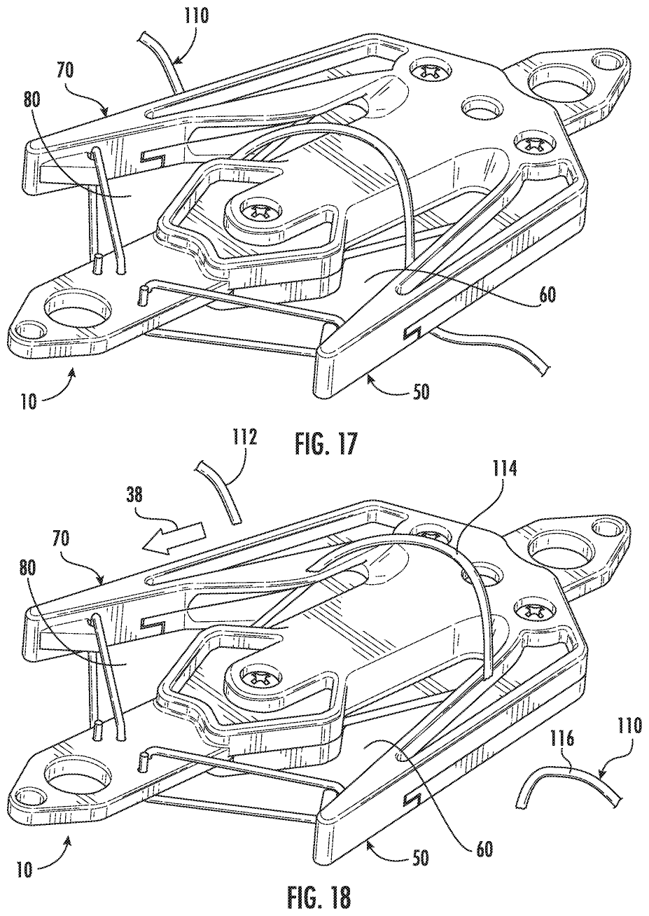

The tool 10 may also be used to cut a command wire, rather than a rope or element that directly secures a device to a structure. As shown in FIGS. 17 and 18, the command wire 100 is drawn into the channels 60 and 80 and is cut on both sides 50 and 70 of the tool 10. The command wire 100 is cut into three pieces 112, 114, and 116, whose ends all separate so that they do not touch and so not electrical connection can be made.

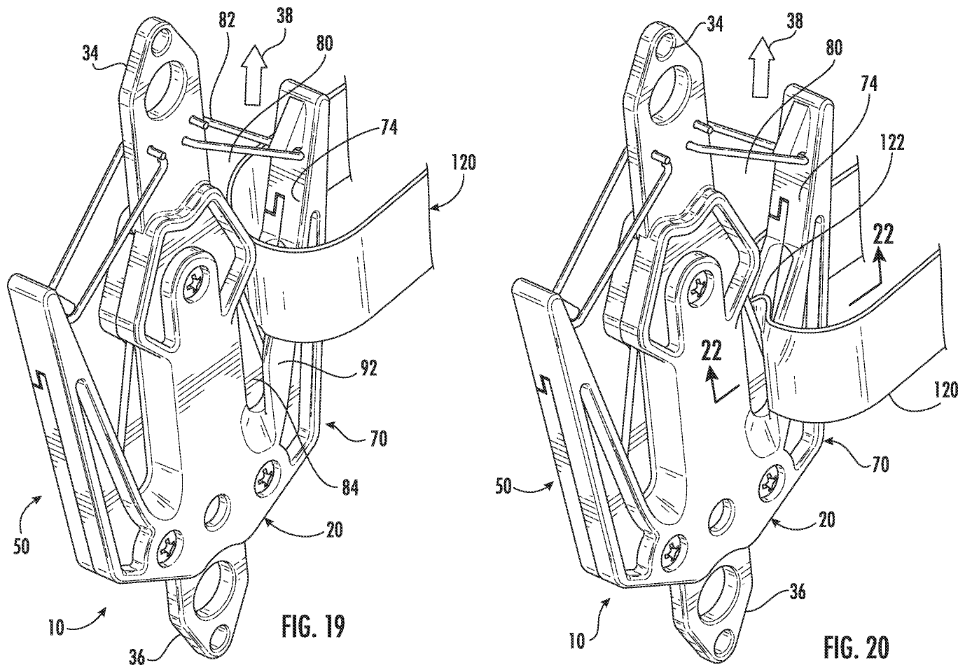

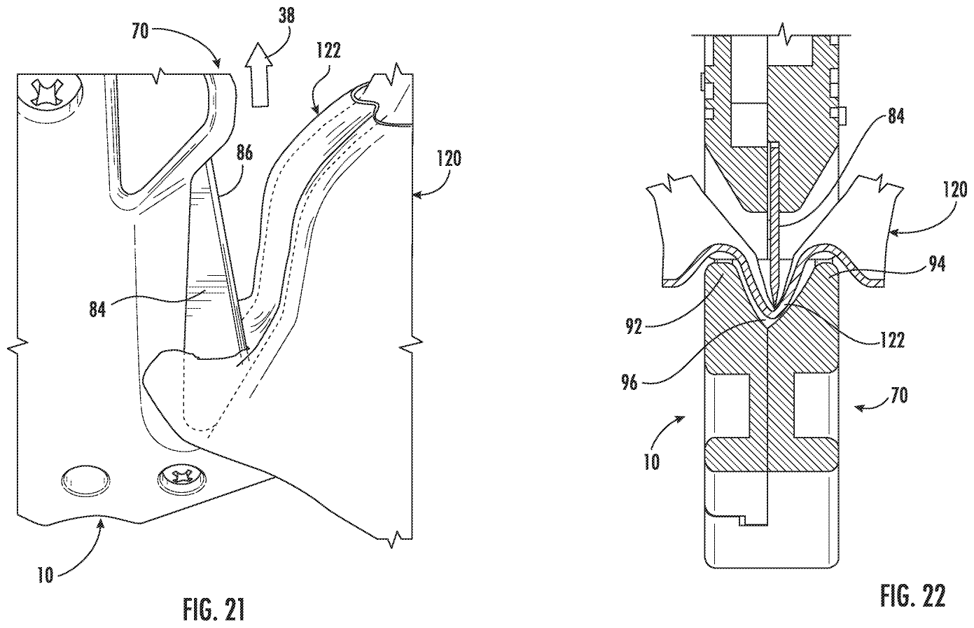

FIGS. 19-22 illustrate the process of cutting a flat workpiece 120, like a web or a strap. To start this process, the tool 10 is maneuvered or placed relative to the web 120 so that the second gate 82, on the web side 70 of the tool, engages the web. The engagement of the second gate 82 with the web 120 causes the second gate to be swung open, allowing the web to enter into the second channel 80. When the web 120 moves far enough into the second channel 80, the second gate 82 closes behind the web, blocking it from exiting the second channel.

Sufficient further movement of the tool 10 in the cutting direction 38 causes the second cutting member 84, and specifically the second cutting edge 86, to engage the web 120. At this point in the process, if the web 120 is limp or unsupported in the cutting direction 38 and the opposite removal direction 39, the web might tend to collapse across its width in response to the forceful engagement with the second cutting edge 86. Even if the web is taut laterally across the tool 10, the web 120 might still bunch up or buckle or collapse as it moves into engagement with the second cutting edge 86.

In accordance with the present invention, the non-flat configuration of the second wing surface 72 minimizes this possibility. Specifically, the web 120, as it is drawn close to the second cutting member 84, enters the narrowest part of the V-shaped second channel 80. The web 120, riding along the second wing surface 72, is bent and forced into the trough 96 between the ribs 92 and 94. As a result, the portion of the web 120 that is adjacent to the second cutting edge 86 is deformed—it assumes a non-flat, for example curved or arched, structural shape, as illustrated schematically at 122 in FIGS. 20 and 22. This non-planar configuration of the web 120, like a stiffening flange or rib on a plate member, effectively stiffens the web and helps to prevent collapsing in the cutting direction 38. As a result, the second cutting member 84 is able to cut through the web 120 as desired. (As an illustrative example, a piece of paper that is stood up vertically on top of a desk or table, but bent into a V-shape, will resist collapsing when pushed downward.

Variations on the illustrated embodiments are possible in accordance with the invention. All such variations within the skill of one of ordinary skill in the art are intended to be covered by the following claims.

1. A cutting tool for cutting a workpiece such as a rope or a web, comprising:
a body defining first and second channels closed by respective first and second movable gates;
a first cutting member at a narrow end of the first channel, and a second cutting member at a narrow end of the second channel; and
the body having surface portions adjacent to the second cutting member that are adapted to deform a flat workpiece engaging the second cutting member into a non-flat shape to increase the stiffness of the workpiece as it engages the second cutting member.

2. A cutting tool as set forth in claim 1 wherein the surface portions include two ribs with a trough between them.

3. A cutting tool as set forth in claim 2 wherein the body has pulling and pushing connections for enabling pulling or pushing of the tool against the workpiece to cut the workpiece.

4. A cutting tool as set forth in claim 1 wherein the first and second cutting members are blades removably mounted in the body.

5. A cutting tool as set forth in claim 1 wherein the body includes a center post and two wings, each one of the two wings extending at an angle from the center post and defining together with the center post a respective one of the first and second channels.

6. A cutting tool as set forth in claim 5 wherein the respective wing adjacent to the second channel has the surface portions.

7. A cutting tool as set forth in claim 6 wherein the surface portions include two ribs with a trough between them.

8. A cutting tool as set forth in claim 1 further including first and second movable gates at the wide ends of the first and second channels, respectively, for allowing movement of workpieces into the channels and thereafter blocking movement of the workpieces out of the channels.

9. A cutting tool for cutting a workpiece such as a rope or a web, comprising:
a body defining first and second channels closed by respective first and second movable gates;
a first cutting member at a narrow end of the first channel, and a second cutting member at a narrow end of the second channel; and
the body having surface portions including two ribs with a trough between them adjacent to the second cutting member that are adapted to deform a flat workpiece engaging the second cutting member into a non-flat shape to increase the stiffness of the workpiece as it engages the second cutting member;
the body having pulling and pushing connections for enabling pulling or pushing of the tool against the workpiece to cut the workpiece; and
the first and second cutting members being removably mounted in the body.

10. A cutting tool as set forth in claim 9 wherein the body includes a center post and two wings, each one of the two wings extending at an angle from the center post and defining together with the center post a respective one of the first and second channels;
the tool further including first and second movable gates at the wide ends of the first and second channels, respectively, for allowing movement of workpieces into the channels and thereafter blocking movement of the workpieces out of the channels.
